(19) United States
(12) Patent Application Publication
(10) Pub. No.: US 2009/0078164 A1
(43) Pub. Date: Mar. 26, 2009

(54) Use of epoxy derivatives as additives for cementitious building materials

(76) Inventors: Stefan Ingrisch, Truchtlaching (DE); Gerhard Albrecht, Tacherting (DE); Bogdan Moraru, Rosenheim (DE); Katja Neuer, Schnaitsee (DE); Stefan Thaler, Trostberg (DE); Mathias Bauer, Trostberg (DE)

Correspondence Address: FULBRIGHT & JAWORSKI, LLP, 666 FIFTH AVE, NEW YORK, NY, 10103-3198, US

(21) Appl. No.: 11/919,611

(22) PCT Filed: May 16, 2006
(86) PCT No.: PCT/EP2006/004618

§ 371 Date: Oct. 30, 2007

(30) Foreign Application Priority Data
May 18, 2005 (DE) 10 2005 022 852.6

(51) Int. Cl. C08L 63/00

(52) U.S. Cl. 106/810

(57) ABSTRACT

The present invention relates to the use of epoxy derivatives which have been prepared by reacting a di-, tri- or tetraglycidyl compound (A) with an optionally unsaturated reactive component (B) consisting of a C₈-C₂₈-fatty acid, a C₈-C₂₈-alcohol or a secondary C₈-C₂₈-amine as additives to cementitious building materials. The epoxy derivatives proposed according to the invention are outstandingly suitable as compositions for preventing or suppressing efflorescence on surfaces of set cementitious building materials and/or for hydrophobing the corresponding cementitious systems. In addition, the cementitious products take up substantially less water owing to the additives proposed according to the invention, with the result that frost damage and rapid rusting of the reinforcing steel can be substantially reduced.

The present invention relates to the use of epoxy derivatives as an additive for cementitious building materials (such as, for example, concrete or mortar), which is used in particular for the mass hydrophobing and/or for the suppression of efflorescence on surfaces of set cementitious building materials.

A known problem in the case of cement-based building materials is the occurrence of so-called efflorescence, a distinction being made between primary and secondary efflorescence. The first-mentioned arises as early as during setting, for example in the case of concrete, the capillaries of the fresh concrete being filled with an aqueous solution of the water-soluble substances of the cement, substantially calcium hydroxide. On setting, the calcium hydroxide on the concrete surface reacts with the carbon dioxide of the air with formation of sparingly soluble calcium carbonate. As a result of the precipitation of calcium carbonate, the calcium hydroxide concentration at the capillary mouth is lower than in the interior of the capillaries. Fresh calcium hydroxide therefore continuously passes by diffusion from the lower layers of the concrete to the capillary mouth and in turn reacts with CO₂ to give calcium carbonate. The corresponding process comes to a stop only when the capillary mouths have been closed by calcium carbonate. Such primary efflorescence occurs to a particularly pronounced extent if a film of condensed water is present on the concrete surface, because the calcium hydroxide can then be distributed over the entire concrete surface and can cover the latter with water-insoluble calcium carbonate after the reaction with carbon dioxide.

In addition, open air weathering of completely set concrete can also lead to spot formation, which are generally designated as secondary efflorescence. This secondary efflorescence lasts as a rule for 1 to 2 years, the slow formation of water-soluble calcium bicarbonate from calcium carbonate being regarded as the cause.

Since the visual appearance of such building components covered with efflorescence is very greatly impaired, particularly in the case of colored concrete products, there has been no lack of attempts to prevent or to suppress this efflorescence by various measures.

In this regard, the prior art proposed two basic possibilities, neither of which however has led to satisfactory results. Firstly, the surfaces of set cement or concrete products are provided with special coatings, especially various silicate and acrylate coatings having been recommended. However, the fact that these subsequent coatings are relatively inconvenient and uneconomical is disadvantageous in the case of this process.

For this reason, attempts have been made to add to the building materials, prior to the setting thereof, suitable additives which are intended to prevent or suppress the formation of efflorescence.

Thus, DE 32 29 564 A1 discloses the additional use of chalk, for example in the form of an aqueous chalk slurry, in the production of colored pre-cast concrete. This is intended to shift the gradient of formation of calcium carbonate on the surface by offering excess calcium carbonate at the very beginning of the solidification process.

Finally, EP 92 242 A1 proposes the addition of surface-active polymers to the concrete for preventing efflorescence. These surface-active polymers are said to lose their surface activity irreversibly during setting of the concrete and to be converted into water-insoluble products thereby.

In practice, water repellents of this type have not become established for unset building materials since they do not have a reliable effect under the different weathering conditions.

It was therefore the object of the present invention to provide a composition for preventing efflorescence on surfaces of set cementitious building materials and/or for mass hydrophobing, which does not have said disadvantages of the prior art but effectively and reliably prevents the efflorescence of cementitious building materials. This object was achieved, according to the invention, by using epoxy derivatives which have been prepared by reacting a di-, tri- or tetraglycidyl compound (A) with an optionally unsaturated reactive component (B) consisting of a C₈-C₂₈-fatty acid, a C₈-C₂₈-alcohol or a secondary C₈-C₂₈-amine as additives for cementitious building materials.

It has surprisingly been found here that these epoxy derivatives are excellently suitable as compositions for preventing efflorescence and/or for hydrophobing cementitious building materials. In addition, the cementitious products take up substantially less water owing to the additives according to the invention, with the result that frost damage and rapid rusting of the reinforcing steel can be substantially reduced.

According to the invention, epoxy derivatives which have been prepared by reacting a di-, tri- or tetraglycidyl compound (A) with a reactive component (B) are used.

Glycidyl compounds which are selected from the group consisting of cyclohexanedimethanol diglycidyl ether, glyceryl triglycidyl ether, neopentyl glycol diglycidyl ether, pentaerythrityl tetraglycidyl ether, 1,6-hexanediol diglycidyl ether, polypropylene glycol diglycidyl ether, polyethylene glycol diglycidyl ether, trimethylolpropane triglycidyl ether, bisphenol A diglycidyl ether, bisphenol F diglycidyl ether, 4,4′-methylenebis(N,N-diglycidylaniline), tetraphenylolethane glycidyl ether, N,N-diglycidylaniline, diethylene glycol diglycidyl ether, 1,4-butanediol diglycidyl ether and mixtures thereof are particularly advantageously used.

It is to be regarded as essential to the invention that the reactive component (B) consists of a C₈-C₂₈-fatty acid, a C₈-C₂₈-alcohol or a secondary C₈-C₂₈-amine, it being possible for the reactive component to have saturated or unsaturated radicals.

From the group consisting of the fatty acids, tall oil fatty acid, stearic acid, palmitic acid, sunflower oil fatty acid, coconut oil fatty acid (C₈-C₁₈), coconut oil fatty acid (C₁₂-C₁₈), soybean oil fatty acid, linseed oil fatty acid, dodecanoic acid, oleic acid, linoleic acid, palm kernel oil fatty acid, palm oil fatty acid, linolenic acid and/or arachidonic acid are to be regarded as being preferred. In the case of the C₈-C₂₈-alcohols, in particular 1-eicosanol, 1-octadecanol, 1-hexadecanol, 1-tetradecanol, 1-dodecanol, 1-decanol and 1-octanol have proven useful. In the case of the secondary amines having C₈-C₂₈ carbon atoms, in particular the alkylamines from the group consisting of 2-ethylhexylamine, dipentylamine, dihexylamine, dioctylamine, bis(2-ethylhexyl)amine, N-methyloctadecylamine and didecylamine are used.

The preparation of the glycidyl compound (A) according to the invention with the reactive component (B) has been sufficiently described according to the prior art. Thus, the reaction of epoxides with carboxylic acids is described in “Reaktionen der organsichen Synthese” [Reactions of organic synthesis], Cesare Ferri, 1st edition 1978, page 505, and in “Methoden der organischen Chemie” [Methods of organic chemistry], Houben-Weyl, 4th edition, volume 6/3, page 459, and volume 14/2, pages 507 to 510. Regarding the reaction of epoxides with alcohols, reference may be made to “Methoden der organischen Chemie” [Methods of organic chemistry], Houben-Weyl, 4th edition, volume 6/3, pages 40 to 44, and pages 456 to 458, and volume 14/2, pages 503 to 506, and to “Reaktionen der organischen Synthese” [Reactions of organic synthesis], Cesare Ferri, 1st edition 1978, page 505. The reaction of epoxides with amines is disclosed, for example, in “Methoden der organischen Chemie” [Methods of organic chemistry], Houben-Weyl, 4th edition, volume 14/2, pages 516 to 523, and in “Reaktionen der organischen Synthese” [Reactions of organic synthesis], Cesare Ferri, 1st edition 1978, pages 504 to 505.

The reaction of the glycidyl component (A) with the reactive component (B) is preferably effected at temperatures of from 20 to 250° C., preferably at from 50 to 200° C., more preferably at from 100 to 180° C. and very particularly preferably at from 140 to 160° C., it being possible for the reaction to be effected, if appropriate, in the presence of a catalyst. Thus, it has proven particularly advantageous to resort to basic catalysts, such as, for example, tetraalkylammonium halides or alkali metal hydroxides, in the reaction of the glycidyl component (A) with the fatty acid as reactive component (B). In the case of the reaction of the glycidyl component (A) with an alcohol as reactive component (B), the reaction can be carried out either under acid catalysis (e.g. sulfuric acid, perchloric acid, hydrofluoric acid, boron trifluoride, tin(IV) chloride) or base catalysis (e.g. alkali metal hydroxides, alkali metal alcoholates, tertiary amines).

The reaction of the glycidyl component (A) with the secondary amines as reactive component (B) is effected as a rule without a catalyst, but small amounts of water or alcohol (e.g. phenol) may be added to the reaction mixture. The molar ratio of glycidyl component (A) to the reactive component (B) can be varied within wide limits, but it has proven particularly advantageous to effect the reaction in a stoichiometric or virtually stoichiometric ratio. From 0.9 to 1.1 mol of a reactive component (B) are used per mole of glycidyl radical. In a preferred embodiment, 1 mol of reactive component (B) is used per mole of glycidyl radical.

The epoxy derivatives proposed according to the invention are outstandingly suitable for the mass hydrophobing of cementitious building materials and/or for the suppression of efflorescence on surfaces of set cementitious building materials. Here, the epoxy derivatives are added to the unset cementitious building materials in an amount of from 0.001 to 5% by weight, more preferably from 0.01 to 1% by weight and most preferably from 0.1 to 0.5% by weight, based on the proportion of cement. According to the present invention, all concrete and mortar systems which contain cement as the main binder and optionally also lime, gypsum or anhydrite as a secondary constituent are to be regarded as cementitious building materials.

Here, the epoxy derivatives according to the invention are added directly to the mixed cementitious building materials. However, it is also possible for the purposes of the present invention to add the additives according to the invention to the mixing water or residual water in emulsified form with the aid of external emulsifiers (for example ethoxylated compounds, such as fatty acid ethoxylate, ethoxylated castor oil or ethoxylated fatty amine).

The epoxy derivatives proposed according to the invention are outstandingly suitable as compositions for preventing or suppressing efflorescence on surfaces of set cementitious building materials and/or hydrophobing the corresponding cementitious systems.

In addition, the cementitious products take up substantially less water owing to the additives proposed according to the invention, with the result that frost damage and rapid rusting of the reinforcing steel can be substantially reduced.

The following examples are intended to illustrate the invention in more detail.

### EXAMPLES

### Example 1

Initially introduce 629.8 g (2.1717 mol) of tall oil fatty acid (trade name: Tall oil fatty acid 2%; from Hanf & Nelles) at room temperature into a reaction vessel, add 369.2 g (1.0859 mol) of bisphenol A diglycidyl ether (trade name: Polypox E 270/500; from UPPC) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached. The reaction product is a pale brown viscous liquid.

Duration of reaction: about 9 h.

### Example 1A

60 g of a fatty acid ethoxylate (trade name: Ethylan A3; from AkzoNobel) are initially introduced into a reaction vessel and heated to 45° C. Thereafter, 120 g of the product from example 1 are added to the initially introduced mixture over 1 h. A brownish white viscous mixture forms. 620 g of water are then metered in over 1 h. A milky white dispersion having a solids content of 15% by weight, based on the product from example 1, is finally obtained.

### Example 2

Initially introduce 630.6 g (2.2602 mol) of soybean oil fatty acid (trade name: Nouracid SE 30; from Hanf & Nelles) at room temperature into a reaction vessel, add 368.4 g (0.5650 mol) of pentaerythritol tetraglycidyl ether (trade name: Polypox R16; from UPPC) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached. The reaction product is a pale brown viscous liquid.

Duration of reaction: about 10 h.

### Example 2A

40 g of a fatty acid ethoxylate (trade name: Ethylan A3; from AkzoNobel) are initially introduced into a reaction vessel. Heat initially introduced mixture in the reaction vessel to 45° C. and add 120 g of the product from example 2 over 1 h. A yellowish viscous mixture forms. 640 g of water are then metered in over 1 h. A milky white dispersion having a solids content of 15% by weight, based on the product from example 2, is finally obtained.

### Example 3

Initially introduce 658.6 g (2.3480 mol) of linseed oil fatty acid (trade name: Nouracid LE 80; from Hanf & Nelles) at room temperature into a reaction vessel, add 340.4 g (0.7825 mol) of trimethylolpropane triglycidyl ether (trade name: Polypox R20; from UPPC) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached. The reaction product is a pale brown viscous liquid.

Duration of reaction: about 10 h.

### Example 3A

40 g of ethoxylated castor oil (trade name: Berol 199; from AkzoNobel) are initially introduced into a reaction vessel. Heat initially introduced mixture in the reaction vessel to 45° C. and add 120 g of the product from example 3 over 1 h. A yellowish viscous mixture forms. 640 g of water are then metered in over 1 h. A milky white dispersion having a solids content of 15% by weight, based on the product from example 3, is finally obtained.

### Example 4

Initially introduce 643.4 g (2.2938 mol) of sunflower oil fatty acid (trade name: Nouracid HE30; from Hanf & Nelles) at room temperature into a reaction vessel, add 355.6 g (1.1471 mol) of neopentylglycol diglycidyl ether (trade name: Polypox R14; from UPPC) and then add 1.0 g of tetrabutylammonium bromide (from Aldrich). The reaction space is flushed with nitrogen and the reaction mixture is heated to 150° C. This temperature is maintained until an acid number of <2 is reached. The reaction product is a pale brown viscous liquid.

Duration of reaction: about 8 h.

### Example 4A

40 g of an ethoxylated castor oil (trade name: Berol 199; from AkzoNobel) are initially introduced into a reaction vessel. Heat initially introduced mixture in the reaction vessel to 45° C. and add 120 g of the product from example 4 over 1 h. A yellowish viscous mixture forms. 640 g of water are then metered in over 1 h. A milky white dispersion having a solids content of 15% by weight, based on the product from example 4, is finally obtained.

### Example 5

Initially introduce 121.7 g (0.4292 mol) of N-methyloctadecylamine (from Aldrich) at room temperature into a reaction vessel, add 78.1 g (0.2146 mol) of bisphenol A diglycidyl ether (trade name: Araldit GY 240; from Huntsman) and then add 0.2 g (0.0006 mol) of tetrabutylammonium bromide (from Aldrich). The reaction space is flushed with nitrogen and the reaction mixture is heated to 80° C. This temperature is maintained until no more secondary amine is detectable.

Duration of reaction: about 4 h.

The reaction product is a pale brown viscous liquid.

### Example 5A

60 g of an ethoxylated fatty amine (trade name: Berol 386; from AkzoNobel) are initially introduced into a reaction vessel and heated to 55° C. Thereafter, 120 g of the product from example 5 are heated to 55° C. and added to the initially introduced mixture over 1 h. A white viscous mixture forms. 620 g of water are then metered in over 1 h. A milky white dispersion having a solids content of 15% by weight, based on the product from example 5, is finally obtained.

### Example 6

Initially introduce 584.2 g (2.6922 mol) of coconut oil fatty acid C₁₂-C₁₈ (trade name: Kortacid CG; from Hanf & Nelles) at room temperature into a reaction vessel, add 414.6 g (1.3461 mol) of 1,6-hexanediol diglycidyl ether (trade name: Polypox R18; from Huntsman) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached. The reaction product is a pale brown viscous liquid.

Duration of reaction: about 8 h.

### Example 6A

40 g of a fatty acid ethoxylate (trade name: Ethylan A3; from AkzoNobel) are initially introduced into a reaction vessel. Heat initially introduced mixture in the reaction vessel to 45° C. and add 120 g of the product from example 6 over 1 h. A yellowish viscous mixture forms. 640 g of water are then metered in over 1 h. A milky white dispersion having a solids content of 15% by weight, based on the product from example 6, is finally obtained.

### Example 7

270.5 g (1.00 mol) of 1-octadecanol are initially introduced into a reaction vessel, the reaction space is flushed with nitrogen and the mixture is heated to 90° C. 1.6 g (0.04 mol) of NaOH are added and allowed to react for 2 h. 616.0 g (2.00 mol) of 1,6-hexanediol diglycidyl ether (trade name: Polypox R18; from Huntsman) are then added. The reaction space is again flushed with nitrogen and the reaction mixture is heated to 130° C. This temperature is maintained for 10 h.

At room temperature, the reaction product is a white waxy solid which is better used as an additive in the form of an aqueous emulsion.

### Example 7A

60 g of an ethoxylated fatty amine (trade name: Berol 386; from AkzoNobel) are initially introduced into a reaction vessel and heated to 55° C. Thereafter, 120 g of the product from example 7 are heated to 55° C. and added to the initially introduced mixture over 1 h. A brownish white viscous mixture forms. 620 g of water are then metered in over 1 h. A milky white dispersion having a solids content of 15% by weight, based on the product from example 7, is finally obtained.

### Testing of the Products Prepared

The test specimens were prepared by the following method and tested with regard to their efflorescence behavior:

Usually, a mixture (11 kg) is prepared in a positive mixer according to the following formulation: all aggregates first being mixed in the dry state for 10 sec. Thereafter, the initially introduced water is added and mixed for 2 min, followed by the addition of the remaining water, duration of mixing 2 min. The additive is added either to the remaining water (addition RW=addition of the additive to the remaining water) or to the concrete mix (addition CM=addition of the additive to the concrete mix):

| 380 kg/m³ | cement (Bernburg CEM I 42.5 R; 380 kg/m³) |
|---|---|
| 1104 kg/m³ | sand 0/2 |
| 296 kg/m³ | gravel 2/5 |
| 296 kg/m³ | gravel 5/8 |
| 137 kg/m³ | water |
| w/c: | 0.36 |

The additive is used in different doses, based on the cement, in the mixture and added either to the remaining water or to the concrete mix. The data on the metering of the additive are always based on solid (additive) to solid (cement). The water content of the additive is subtracted from the amount of mixing water.

For the production of the test specimens, in each case exactly 1300 g of the fresh concrete mix are introduced into round molds and compacted with an applied weight of 30 kg on a vibrating table for 90 sec. Thereafter, the fresh test specimen is removed from the mold and stored for 2 days in a conditioning chamber (20° C., 65% relative humidity) for setting. The lightness of the test specimens is then measured using a color photospectrometer (Color-Guide sphere spin, Byk Gardner) (L1), a template having 9 measuring points being placed on the test specimen so that the same points are measured subsequently in the second measurement. The mean value L1 is obtained from these 9 points. Thereafter, the bricks are immersed for about 2 sec in distilled water and packed air-tight in a plastic bag in the damp state. This bag is stored in the conditioning chamber for 10 days. Thereafter, the bricks are unpacked and stored for 2 days in the conditioning chamber for drying. The lightnesses of the test specimens are then measured a second time using template and color photospectrometer (L2). Six test specimens are prepared per mixture (and the mean value calculated therefrom).

The color change of the surface (ΔL) of the test specimen (increase in whiteness) is obtained as: ΔL=L2−L1.

After the lightening (ΔL) of the test specimens by the efflorescence, the homogeneity of the surface was also assessed and the water absorption of the test specimens was determined.

Determination of the water absorption (WA) based on EN ISO 15148:

The dried and set test specimens are weighed (W1) and placed in a water bath so that the bottom rests on the point supports and does not touch the container bottom. Water level about 5 mm above the highest point of the bottom. After 15 min, the test specimens are removed from the water bath and weighed a second time (W2). The test specimen is dried beforehand with a moist, wrung-out sponge.

The water absorption is obtained as: WA=W2−W1.

TABLE 1
(Accelerated efflorescence in the conditioning
chamber, 20° C., 65% relative humidity)

| | Dose | | | | |
|---|---|---|---|---|---|
| | [% by | Addi- | Lightness | Water absorption | Assessment of |
| Ex. | wt.] | tion | difference (ΔL) | (WA) [g] | the surface |
| 1 | 0.25 | CM | 1.2 (7.1) −83% | 3.9 (48.5) −92% | Flawless |
| | 0.10 | CM | 1.4 (7.1) −80% | 4.4 (48.5) −91% | Flawless |
| 1A | 0.25 | RW | 0.9 (7.1) −87% | 2.2 (48.5) −95% | Flawless |
| | 0.10 | RW | 1.0 (7.1) −86% | 2.5 (48.5) −95% | Flawless |
| 2 | 0.25 | CM | 1.2 (8.3) −86% | 3.3 (42.2) −92% | Flawless |
| | 0.10 | CM | 1.5 (8.3) −82% | 3.9 (42.2) −91% | Flawless |
| 2A | 0.25 | RW | 1.1 (8.3) −87% | 3.0 (42.2) −93% | Flawless |
| | 0.10 | RW | 1.3 (8.3) −84% | 3.7 (42.2) −91% | Flawless |
| 3 | 0.25 | CM | 1.3 (6.4) −80% | 3.9 (50.6) −92% | Flawless |
| | 0.10 | CM | 1.5 (6.4) −77% | 5.1 (50.6) −90% | Flawless |
| 3A | 0.25 | RW | 1.0 (6.4) −84% | 3.0 (50.6) −96% | Flawless |
| | 0.10 | RW | 1.3 (6.4) −80% | 4.1 (50.6) −92% | Flawless |
| 4 | 0.25 | CM | 0.9 (7.7) −88% | 2.3 (41.1) −94% | Flawless |
| | 0.10 | CM | 1.1 (7.7) −86% | 3.0 (41.1) −93% | Flawless |
| 4A | 0.25 | RW | 0.8 (7.7) −90% | 2.1 (41.1) −95% | Flawless |
| | 0.10 | RW | 1.0 (7.7) −87% | 2.7 (41.1) −93% | Flawless |
| 5 | 0.25 | CM | 1.2 (7.9) −85% | 3.4 (52.2) −93% | Flawless |
| | 0.10 | CM | 1.5 (7.9) −81% | 4.1 (52.2) −92% | Flawless |
| 5A | 0.25 | RW | 1.1 (7.9) −86% | 3.7 (52.5) −93% | Flawless |
| | 0.10 | RW | 1.4 (7.9) −82% | 4.5 (52.5) −91% | Flawless |
| 6 | 0.25 | CM | 0.9 (8.0) −89% | 2.4 (44.7) −95% | Flawless |
| | 0.10 | CM | 1.1 (8.0) −86% | 2.9 (44.7) −94% | Flawless |
| 6A | 0.25 | RW | 0.8 (8.0) −90% | 1.4 (44.7) −97% | Flawless |
| | 0.10 | RW | 1.1 (8.0) −86% | 2.0 (44.7) −96% | Flawless |
| 7A | 0.25 | RW | 1.2 (8.3) −86% | 4.1 (55.3) −93% | Flawless |
| | 0.10 | RW | 1.5 (8.3) −82% | 4.9 (55.3) −91% | Flawless |

Addition CM = addition of the additive to the concrete mix
Addition RW = addition of the additive to the remaining water

The values in brackets are the results of the zero mixes (without additive). The percentage values indicate by how much the additive has reduced the lightness or the water absorption in each case in comparison with the zero mix (without additive).

The dosages indicate the solid of the additive, based on the cement in the mix.

1-10. (canceled)

11. A method comprising adding an epoxy derivative prepared by reacting a di-, tri- or tetraglycidyl compound (A) with an optionally unsaturated reactive component (B) consisting of a C₈-C₂₈-fatty acid, a C₈-C₂₈-alcohol or a secondary C₈-C₂₈-amine to a cementitious building material.

12. The method as claimed in claim 11, wherein the compound (A) is based on at least one glycidyl compound selected from the group consisting of cyclohexanedimethanol diglycidyl ether, glyceryl triglycidyl ether, neopentylglycol diglycidyl ether, pentaerythrityl tetraglycidyl ether, 1,6-hexanediol diglycidyl ether, polypropylene glycol diglycidyl ether, polyethylene glycol diglycidyl ether, trimethylolpropane triglycidyl ether, bisphenol A diglycidyl ether, bisphenol F diglycidyl ether, 4,4′-methylenebis(N,N-diglycidylaniline), tetraphenylolethane glycidyl ether, N,N-diglycidylaniline, diethylene glycol diglycidyl ether and 1,4-butanediol diglycidyl ether.

13. The method of claim 11, wherein the reactive component (B) is selected fatty acid from the group consisting of tall oil fatty acid, stearic acid, palmitic acid, sunflower oil fatty acid, coconut oil fatty acid (C₈-C₁₈), coconut oil fatty acid (C₁₂-C₁₈), soybean oil fatty acid, linseed oil fatty acid, dodecanoic acid, oleic acid, linoleic acid, palm kernel oil fatty acid, palm oil fatty acid, linolenic acid and arachidonic acid.

14. The method of claim 11, wherein reactive component (B) is an alkanol selected from the group consisting of 1-eicosanol, 1-octadecanol, 1-hexadecanol, 1-tetradecanol, 1-dodecanol, 1-decanol and 1-octanol.

15. The method of claim 11, wherein reactive component B) is a dialkylamine selected from the group consisting of 2-ethylhexylamine, dipentylamine, dihexylamine, dioctylamine, bis(2-ethylhexyl)amine, N-methyloctadecylamine and didecylamine.

16. The method of claim 11, wherein the reaction of the glycidyl component (A) with the reactive component (B) is carried out at a temperature of from 20 to 250° Ct.

17. The method of claim 11, wherein the reaction of the glycidyl component and the reactive component is effected in a stoichiometric or substantially stoichiometric ratio.

18. The method of claim 11, wherein the epoxy derivative is used for the mass hydrophobing of cementitious building materials.

19. The method of claim 11, wherein the epoxy derivative is present in an amount to suppress efflorescence on a surface of the set cementitious building material.

20. The method of claim 11, wherein the epoxy derivative is added to unset cementitious building material in an amount of from 0.001 to 5% by weight, based on the proportion of cement.

21. The method of claim 16, wherein the reaction of the components (A) and (B) are conducted in the presence of an acidic catalyst or a basic catalyst.
